(19) United States
(12) Patent Application Publication
(10) Pub. No.: US 2018/0206474 A1
(43) Pub. Date: Jul. 26, 2018

(54) SPRAY BOOM ATTACHMENT SYSTEM AND METHODS OF USING SAME

(71) Applicant: Robert Vaughan, Calabash, NC (US)

(72) Inventor: Robert Vaughan, Calabash, NC (US)

(21) Appl. No.: 15/879,502

(22) Filed: Jan. 25, 2018

Related U.S. Application Data
(60) Provisional application No. 62/450,317, filed on Jan. 25, 2017.

(51) Int. Cl. A01M 7/00

(52) U.S. Cl. CPC A01M 7/0053; A01M 7/0082; A01M 7/0071

(57) ABSTRACT

A spray boom attachment system for use with at least one traditional spray boom of a traditional spray boom system of a vehicle transporting a fluid reservoir, comprising: at least one quick attachment spray boom; at least one nozzle body mounted under the at least one quick attachment spray boom; and, at least one cap mounted on the at least one quick attachment spray boom; wherein the at least one nozzle body is placed in fluid communication with the fluid reservoir and wherein the at least one cap is removably attached to the traditional spray boom.

### RELATED APPLICATIONS

This application claims the benefit of priority under 35 USC § 119(e) of U.S. Provisional Patent Application No. 62/450,317 filed Jan. 25, 2017, the contents of which are incorporated herein by reference in their entirety.

### FIELD AND BACKGROUND OF THE INVENTION

The present invention, in some embodiments thereof, relates to the groundskeeping field and, more particularly, but not exclusively, to a system for facilitating certain turf-care aspects of groundskeeping.

Ground/turf spraying devices are used to rapidly deploy a fluid substance over the surface of the ground. Traditional spraying devices use booms with nozzles, connected to a fluid reservoir, to spray fluid from the reservoir out of the nozzles and onto the ground. Typically, the nozzles are spaced 20 inches apart for spraying colorants/pigments onto the ground surface. Typically, tips of the nozzles are positioned 20 inches above the ground surface during spraying. Depending on the particular use for the spraying device, these specifications may not be ideal, or even effective, however any modification of these specifications is time consuming, uneconomical, risks misapplication, and requires spray device customization.

### SUMMARY OF THE INVENTION

According to an aspect of some embodiments of the present invention there is provided a spray boom attachment system for use with a second spray boom system attached to a vehicle transporting a fluid reservoir, comprising: at least one quick attachment spray boom; at least one nozzle body mounted under the at least one quick attachment spray boom; and, at least one cap mounted on the at least one quick attachment spray boom; wherein the at least one nozzle body is placed in fluid communication with the fluid reservoir and wherein the at least one cap is removably attached to the second spray boom system.

In an embodiment of the invention, the spray boom attachment system further comprises a plurality of nozzle bodies configured at a different nozzle spacing than a nozzle spacing of the second spray boom system.

In an embodiment of the invention, the spray boom attachment system further comprises at least one of a screw and a protective cover pipe, wherein the at least one of the screw and the protective cover pipe create a desired amount of spacing between the quick attachment spray boom and the second spray boom system.

In an embodiment of the invention, the at least one cap is removably attached to a nozzle of the second spray boom system.

In an embodiment of the invention, the nozzle spacing of the quick attachment spray boom is less than 20 inches.

In an embodiment of the invention, the nozzle spacing of the quick attachment spray boom is more than 20 inches.

In an embodiment of the invention, the desired amount of spacing between the quick attachment spray boom and the second spray boom system is 2 inches or more.

In an embodiment of the invention, the at least one quick attachment spray boom is a center boom.

In an embodiment of the invention, the at least one quick attachment spray boom is at least one side boom.

In an embodiment of the invention, the spray boom attachment system further comprises a fluid supply hose for placing the at least one nozzle body to the fluid reservoir in fluid communication.

In an embodiment of the invention, the spray boom attachment system further comprises at least one of a barb fitting, a hose adapter, a freeze plug, and a clamp assembly.

In an embodiment of the invention, the at least one quick attachment spray boom includes a center boom, a left side boom and a right side boom.

There is further provided in accordance with an aspect of the invention, a method of using a spray boom attachment system with a second spray boom system of a vehicle transporting a fluid reservoir, comprising: removably attaching at least one cap of a quick attachment spray boom of the spray boom attachment system to a nozzle of the second spray boom system; removably attaching a fluid supply hose to a hose adapter of the quick attachment spray boom, to provide fluid communication between the fluid reservoir and the quick attachment spray boom; spraying fluid from the fluid reservoir from at least one nozzle body of the quick attachment spray boom.

In an embodiment of the invention, the method further comprises changing the nozzle spacing of the second spray boom system by removably attaching the quick attachment spray boom to the second spray boom system.

In an embodiment of the invention, the method further comprises changing the effective height for spraying by removably attaching the quick attachment spray boom to the second spray boom system.

In an embodiment of the invention, the method further comprises removably attaching a plurality of quick attachment spray booms to the second spray boom system. In an embodiment of the invention, the spraying fluid comprises using the plurality of quick attachment spray booms.

In an embodiment of the invention, the method further comprises removably attaching a plurality caps of the quick attachment spray boom to the second spray boom system.

In an embodiment of the invention, the method further comprises reversing the removably attaching the fluid supply hose and reversing the removably attaching the at least one cap to remove the quick attachment spray boom from the second spray boom system.

In an embodiment of the invention, changing the nozzle spacing of the second spray boom system changes the nozzle spacing to less than or more than 20 inches.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

Some embodiments of the invention are herein described, by way of example only, with reference to the accompanying drawings and pictures. With specific reference now to the drawings in detail, it is stressed that the particulars shown are by way of example, are not necessarily to scale, and are for purposes of illustrative discussion of embodiments of the invention. In this regard, the description taken with the drawings makes apparent to those skilled in the art how embodiments of the invention may be practiced.

In the drawings:

FIG. 1 is a block diagram depicting a spray boom attachment system;

FIG. 2 is a schematic diagram depicting an exemplary left/right boom of the system of FIG. 1;

FIG. 3 is a schematic diagram depicting an exemplary center boom of the system of FIG. 1;

FIG. 4 is a picture of an exemplary center boom of the system of FIG. 1;

FIGS. 5-7 partially show assembly steps of an exemplary spray boom attachment system;

FIG. 8 is a picture of a cap, a cover pipe, a nozzle body, a hose adapter and accompanying barb fitting of a boom of the system of FIG. 1;

FIG. 9 is a picture from the side of the unclamped cap, cover pipe, and nozzle body assembly shown in FIG. 8;

FIG. 10 is a picture of an exemplary spray boom attachment system installed on a vehicle;

FIG. 11 is a picture of a partial view of a spray boom attachment system attached to a traditional spray boom; and,

FIG. 12 is a flowchart of a method of using the spray boom attachment system of FIG. 1.

### DESCRIPTION OF SPECIFIC EMBODIMENTS OF THE INVENTION

The present invention, in some embodiments thereof, relates to the groundskeeping field and, more particularly, but not exclusively, to a system for facilitating certain turf-care aspects of groundskeeping.

Before explaining at least one embodiment of the invention in detail, it is to be understood that the invention is not necessarily limited in its application to the details of construction and the arrangement of the components and/or methods set forth in the following description and/or illustrated in the drawings and/or the pictures. The invention is capable of other embodiments or of being practiced or carried out in various ways. As used herein, “under” or “below” means in the direction of the ground or turf surface and “over” or “above” means in the direction of the sky, opposite the ground.

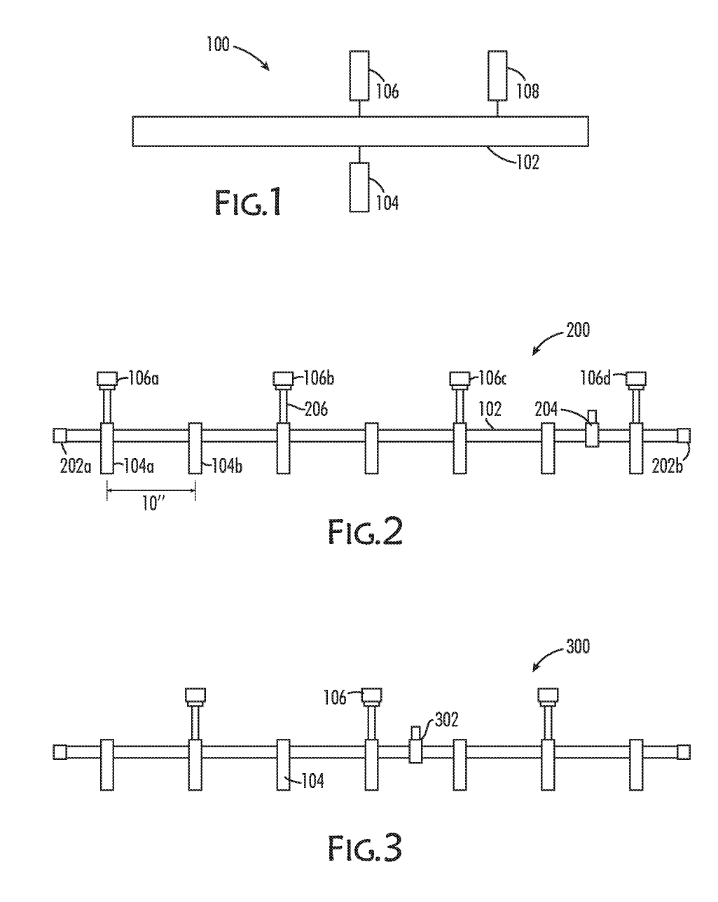

Referring now to the drawings, FIG. 1 is a block diagram depicting a spray boom attachment system 100. The spray boom attachment system 100 is intended to be quickly and/or easily removably attached to other spray boom systems being used in the groundskeeping industry to spray liquids, such as pesticides, herbicides, insecticides, fertilizer, soil amendments, hydroseed, wetting agents, colorants and/or pigments to turf, in order to change various aspects of how these substances are applied. This includes golf courses, lawn and landscape care, sport turf, commercial turf, and turf related to agriculture. The industry standard for spray booms is a 20″ nozzle spacing at 20″ or more off the ground, this arrangement is referred to herein as a “traditional spray boom” or “traditional spray boom system”.

The spray boom attachment system 100 described herein is designed to attach to a second spray boom system, for example, a traditional spray boom quickly and/or easily to effectively adjust the nozzle spacing from 20″ to a different spacing and/or to effectively adjust the height of the boom being used to some distance closer to the ground/turf than the traditional boom height. As used herein, the “effective” height means the distance between the turf/ground being sprayed and the ground-facing tip of the nozzle performing the spraying. In some embodiments of the invention, the effective nozzle spacing of the spray boom attachment system 100 is 20″ or less. Optionally, the spacing is 10″ or less. In some embodiments of the invention, the effective height of the spray boom attachment system 100 is 1″-30″. Optionally, the effective height of the spray boom attachment system 100 is 14″. In some embodiments of the invention, the nozzle spacing is 10″ and the effective height of the spray boom attachment system 100 is 12″-15″ above the ground. It should be understood that these spacings and boom heights are by way of example only, and that they could be more or less than described herein and/or can be used in different combinations of spacing and height depending on the application or context of use.

In some embodiments, attachment or detachment of the quick spray boom system 100 takes 10 minutes or less. Optionally, attachment or detachment of the quick spray boom system 100 to/from the traditional spray boom takes as little as 5-7 minutes.

In some embodiments of the invention, the spray boom system 100 comprises at least one quick attachment spray boom 102 with at least one nozzle body 104, and at least one cap 106, wherein the nozzle body 104 is positioned under the boom 102 facing the underlying ground and the cap 106 is positioned above the boom 102, on the opposite side of the boom from the nozzle body 104.

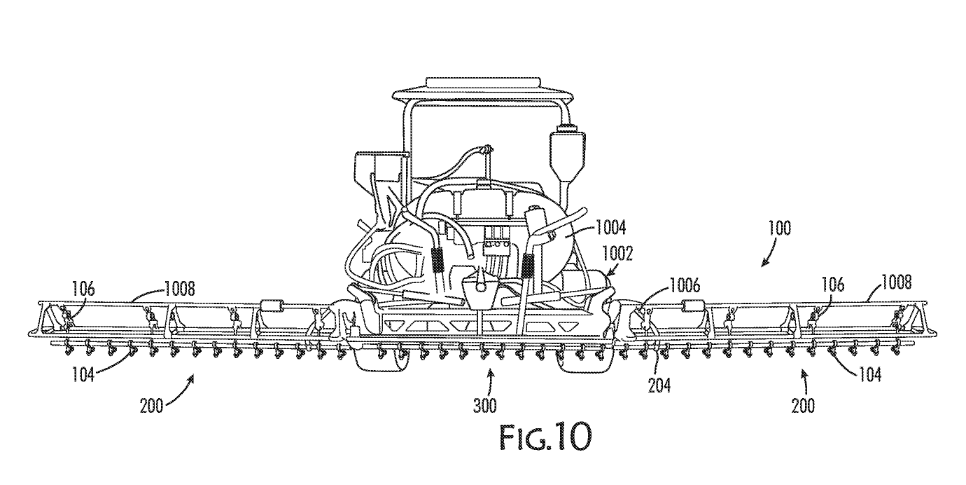

In an embodiment of the invention, the cap 106 is used to connect the boom 102 to a traditional spray boom (depicted in FIG. 10), for example by screwing onto a nozzle of the traditional spray boom (optionally, positioned above, below or level with the quick attachment spray boom 102) to provide a stable, but reversible, attachment between the quick attachment spray boom 102 to the traditional spray boom.

In some embodiments of the invention, the nozzle body 104 is used to apply pigment or colorant to underlying turf, which is fed to the spray boom attachment system 100 by a fluid reservoir, typically mounted on the same vehicle as the system 100, through a hose adapter 108 and barb fitting assembly configured as a counterpart to a fluid supply hose and in fluid communication with the fluid reservoir. The hose adapter 108 and barb fitting assembly is optionally positioned on the quick attachment boom 102 in a position which parallels the location of the hose fitting on the traditional boom, such that the fluid supply hose can be rapidly detached from the traditional boom and attached to the quick attachment boom 102.

In an embodiment of the invention, separation of the quick attachment boom 102 from the traditional boom is at least partially determined by the length of screw used between the cap 106 and the boom 102. For example, since traditional booms are effectively 20″ above the ground, the screw length is selected based on a preference for an effective height above the ground of the quick attachment boom 102. Optionally, a protective cover pipe is disposed around the screw, which is positioned in a lumen of the cover pipe, and between the cap 106 and the boom 102.

In some embodiments of the invention, components (booms, nozzles, hose adaptor, barb fittings, caps, etc.) of the spray boom attachment system 100 are constructed of a light-weight, stiff and colorant/pigment-proof material, such as PVC, plastics, carbon fiber or aluminum. Optionally, some or all of the components are constructed of heavier materials such as steel (e.g. stainless, galvanized, black iron), as examples.

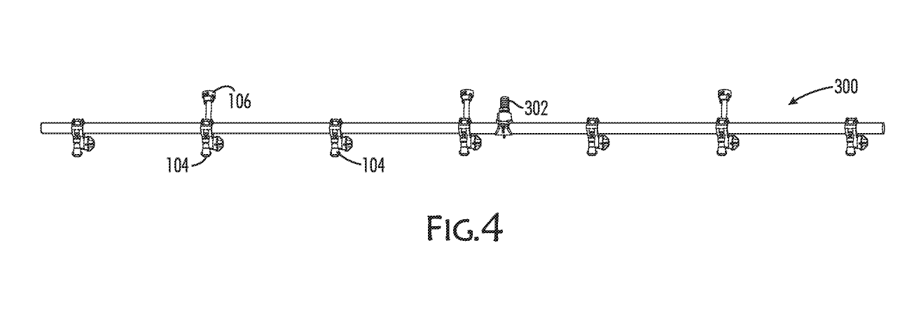

FIG. 2 is a schematic diagram depicting an exemplary left/right boom 200, constituting a part of the “at least one quick attachment spray boom 102” of the system 100 of FIG. 1. In some embodiments of the invention, the left/right boom 200 is positioned on one or both sides of a vehicle, on traditional side spray booms to which the spray boom attachment system 100 is attached. As described above, at least one cap (e.g. 106a, 106b, 106c, 106d, . . . 106n) is used to removably attach to hold the quick attachment boom 102 to the traditional spray boom, which remains in its nominal operating position even while the quick attachment spray boom assembly system 100 is attached. In some embodiments of the invention, the cap 106 is attached to the boom 102 by a barb fitting and 2″ screw (shown in more detail in FIG. 7). The screw is covered by ⅜″ plastic protective cover pipe to hide screw and protect the screw, in an embodiment. The protective cover pipe 206 and screw are sized (in major axis length) to give the boom 102 the desired height off the ground by setting the offset distance from the traditional spray boom. In some embodiments, the nozzle bodies 104a, 104b, . . . 104n are spaced 10″ apart. In some embodiments, a plug 202a, 202b, for example an expandable freeze plug, is placed inside each open end of the quick attach boom 102 to prevent colorants/spray fluids from leaking out of the ends of the boom 102. The hose adapter 204 is the component that attaches the already existing fluid supply hose to the quick attach boom 102.

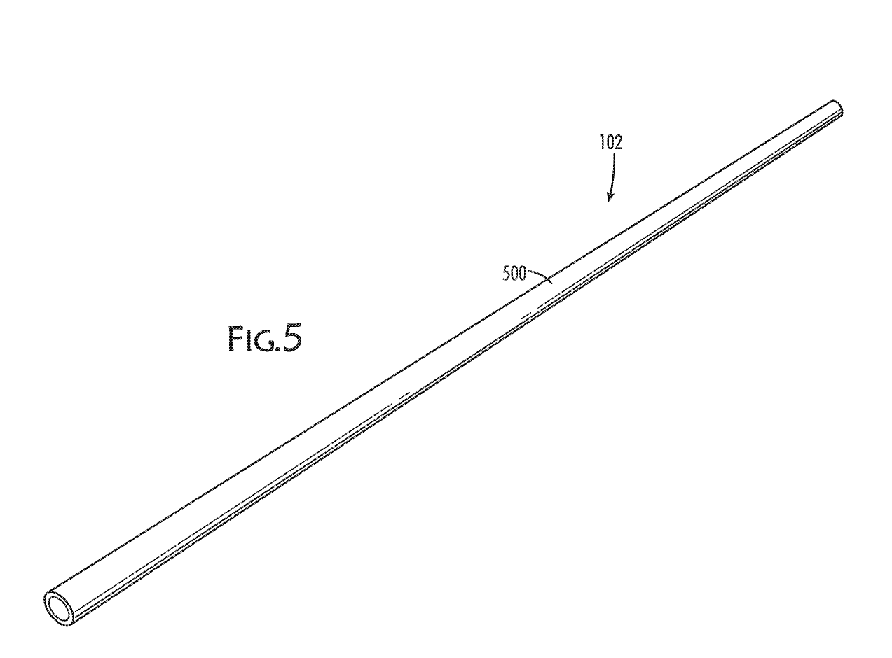

FIG. 3 is a schematic diagram depicting an exemplary center boom 300, constituting a part of the “at least one quick attachment spray boom 102” of the system 100 of FIG. 1. In some embodiments of the invention, the center boom 300 is used at the rear of a vehicle (shown in more detail in FIG. 10), on a traditional center boom to which the spray boom attachment system 100 is attached. Center boom 300 is provided with similar functional features as left/right side boom 200, although in some embodiments, the hose adapter 302 is positioned in a different relative position on the center boom 300 to more closely match the fluid supply hose location on the traditional center boom.

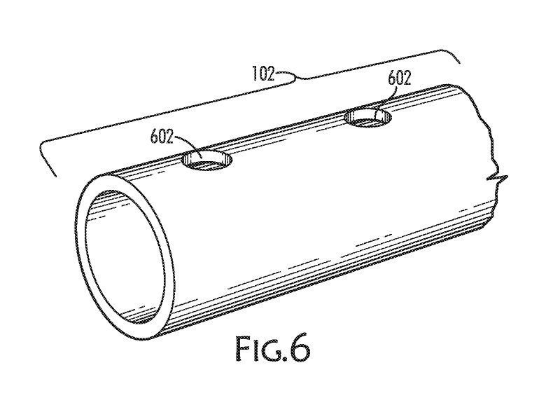

FIG. 4 is a picture of an exemplary center boom 300 of the spray boom attachment system 100, showing at least one cap 106 and at least one nozzle body 104, along with the hose adapter 302.

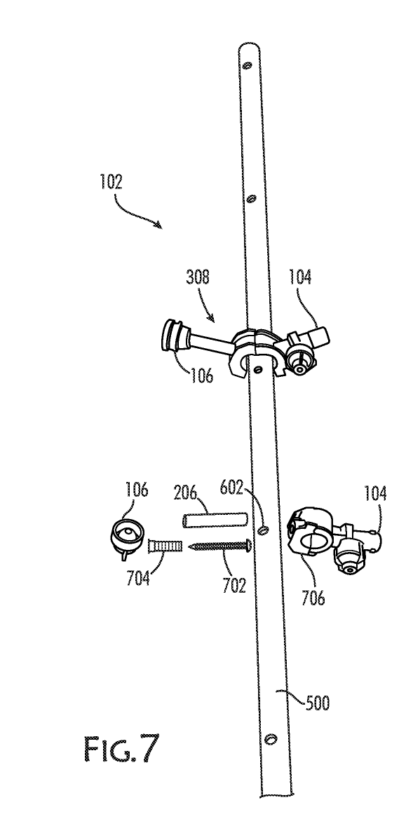

FIGS. 5-7 partially show exemplary assembly stages of a boom 102 of an exemplary spray boom attachment system 100. In FIG. 5, the boom 102 starts with a hollow tube 500, which can be of variable length depending on the use, but in this picture is 64″ long. FIG. 6 shows the hollow tube 500 with holes 602 drilled therein. In an embodiment of the invention, the holes 602 are ⅜″ in diameter and are 10″ apart (from center of hole to center of hole). It should be understood that the hole 602 size and the spacing could vary depending on the intended use of the boom 102. FIG. 7 shows the hollow tube 500 with an exploded cap/nozzle/clamp assembly which includes the cap 106, a barb fitting 704, a protective cover pipe 206, a screw 702, the clamp portion 706 and, a nozzle body 104. An assembled cap/nozzle/clamp assembly 708 is shown partially clamped onto the hollow tube 500.

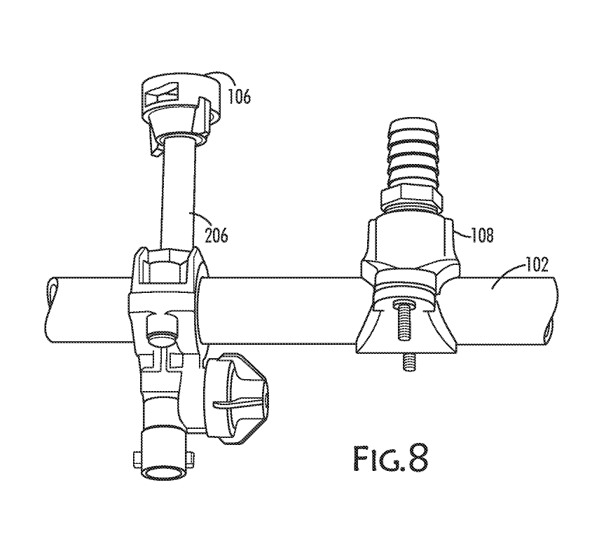

FIG. 8 is a picture of a cap/nozzle/clamp assembly 708, a hose adapter 108 and accompanying barb fitting of a quick attachment spray boom 102, for example a center boom 300.

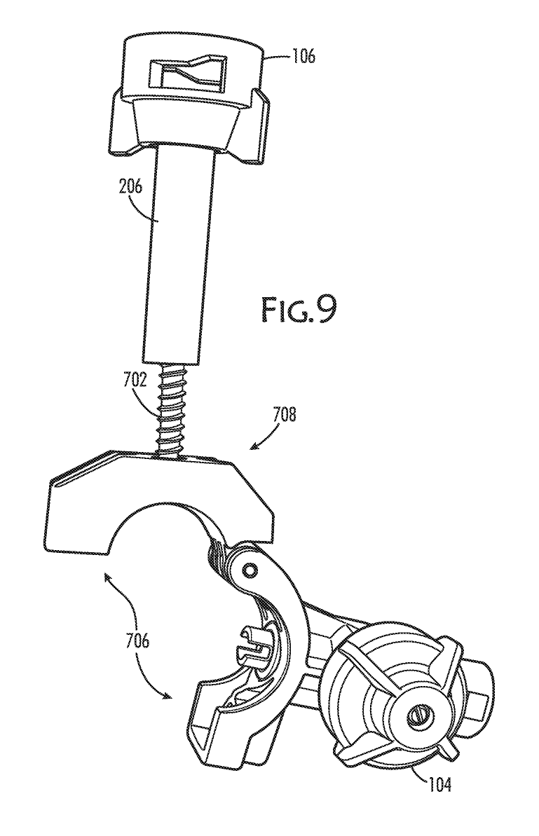

FIG. 9 is a picture from the side of an exemplary, unclamped cap/nozzle/clamp assembly 708 and with the screw 702 partially uncovered by the protective cover pipe 206 for demonstration purposes.

FIG. 10 is a picture of an exemplary spray boom attachment system 100 installed on a traditional spray boom system of a vehicle 1002, in accordance with an exemplary embodiment of the invention. Also shown are a fluid reservoir 1004 and a fluid supply hose 1006 attached to a hose adapter 204 of a side boom 200, placing the boom 200 and the reservoir 1004 in fluid communication. From FIG. 10, it can be seen that left/right side booms 200 are deployed in line with the center boom 300 to provide approximately 16 feet of linear spray coverage area. Optionally, one, two or more of the booms are not aligned. It should be understood that the booms 200, 300 can vary in length individually or all together, depending on the context of use. The left/right side booms 200 and center boom 300 are attached to the traditional booms 1008 using the caps 106. In this example, the nozzle bodies 104 are spaced about 5″ apart, but could be virtually any spacing up to 20″ apart, for example 10″ apart, or even greater than 20″ apart, depending on the application. In some embodiments, one or more of the booms are located in front of the vehicle 1002, instead of or in addition to booms located behind the vehicle (such as shown in FIG. 10).

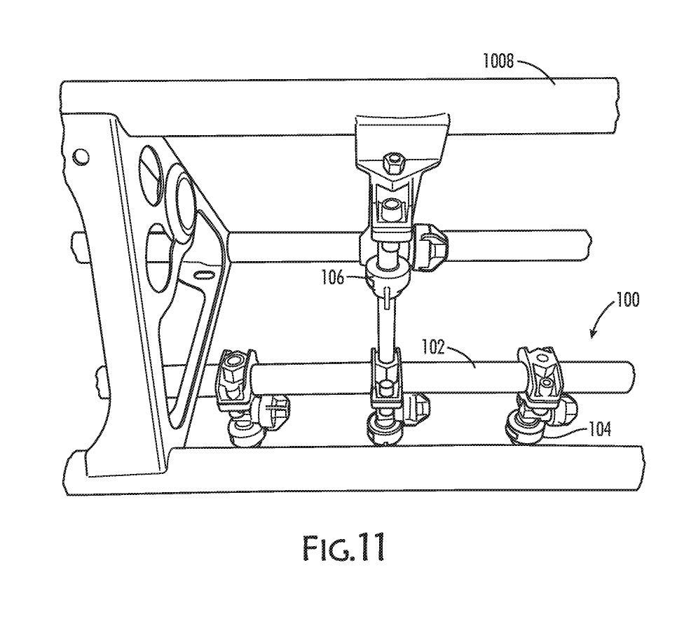

FIG. 11 is a picture of a partial, up-close view of a boom 102 of the spray boom attachment system 100 attached to a traditional spray boom 1008. At least one cap 106 is screwed onto a nozzle of the traditional spray boom 1008 to attach the quick attach boom 102 to the traditional spray boom 1008. Nozzle bodies 104 of the quick attach spray boom 102 are used to apply colorant/pigment at a spacing and/or height that is different than that of the traditional spray boom 1008, which being easy to attach to, and detach from, the traditional spray boom 1008.

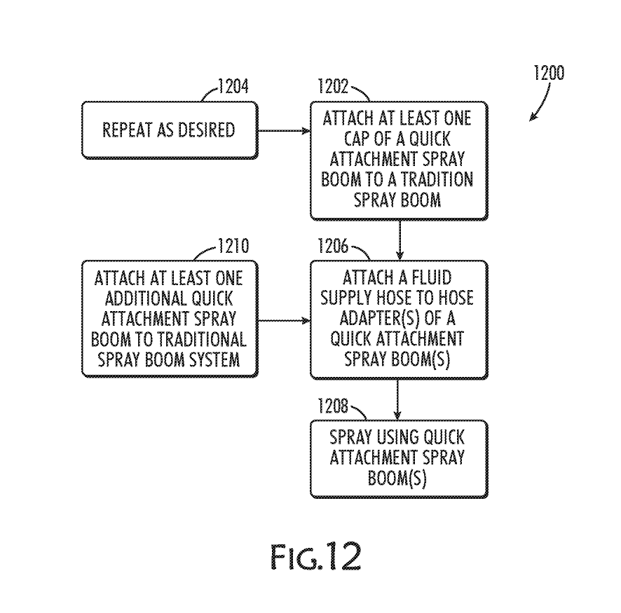

FIG. 12 is a flowchart of a method 1200 of using the spray boom attachment system 100 of FIG. 1. In an embodiment of the invention, at least one cap of a quick attachment spray boom 102, for example a center boom 300, is removably attached (1202) to a nozzle of a traditional spray boom 1008. The cap 106 attaching (1202) is repeated (1204) for as many caps 106 as are desired to adequately and/or stably attach the center boom 300 to the traditional spray boom 1008. A fluid supply hose 1006 is optionally detached from the traditional spray boom 1008 and removably attached (1206) to a hose adapter 302 of the center boom 300. In some embodiments of the invention, spraying (1208) is performed using just the center boom 300, which exhibits a different nozzle body 104 spacing and/or a different height than the traditional boom 1008. In some embodiments of the invention, at least one other quick attachment spray boom 102, for example a left/right side boom 200, is removably attached (1210) to its counterpart traditional spray boom 1008 using a similar procedure as the center boom 300, including placing the at least one left/right side boom 200 into fluid communication with the fluid reservoir 1004 using a fluid supply hose 1006. In some embodiments of the invention, spraying (1208) is performed with two or more quick attach spray booms 102, such as a center boom 300 and two left/right side booms 200 (e.g. one on each side of the center boom 300). In some embodiments of the invention, the actions recited herein are reversed to detach the spray boom attachment system 100.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. Further, described ranges are intended to include numbers outside any range described within statistical error and/or inherent measurement equipment limitations.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A spray boom attachment system for use with a second spray boom system attached to a vehicle transporting a fluid reservoir, comprising:
at least one quick attachment spray boom;
at least one nozzle body mounted under the at least one quick attachment spray boom; and,
at least one cap mounted on the at least one quick attachment spray boom;
wherein the at least one nozzle body is placed in fluid communication with the fluid reservoir and wherein the at least one cap is removably attached to the second spray boom system.

2. The spray boom attachment system according to claim 1, further comprising a plurality of nozzle bodies configured at a different nozzle spacing than a nozzle spacing of the second spray boom system.

3. The spray boom attachment system according to claim 1, further comprising at least one of a screw and a protective cover pipe, wherein the at least one of the screw and the protective cover pipe create a desired amount of spacing between the quick attachment spray boom and the second spray boom system.

4. The spray boom attachment system according to claim 1, wherein the at least one cap is removably attached to a nozzle of the second spray boom system.

5. The spray boom attachment system according to claim 2, wherein the nozzle spacing of the quick attachment spray boom is less than 20 inches.

6. The spray boom attachment system according to claim 2, wherein the nozzle spacing of the quick attachment spray boom is more than 20 inches.

7. The spray boom attachment system according to claim 3, wherein the desired amount of spacing between the quick attachment spray boom and the second spray boom system is 2 inches or more.

8. The spray boom attachment system according to claim 1, where the at least one quick attachment spray boom is a center boom.

9. The spray boom attachment system according to claim 1, where the at least one quick attachment spray boom is at least one side boom.

10. The spray boom attachment system according to claim 1, further comprising a fluid supply hose for placing the at least one nozzle body to the fluid reservoir in fluid communication.

11. The spray boom attachment system according to claim 1, further comprising at least one of a barb fitting, a hose adapter, a freeze plug, and a clamp assembly.

12. The spray boom attachment system according to claim 1, where the at least one quick attachment spray boom includes a center boom, a left side boom and a right side boom.

13. A method of using a spray boom attachment system with a second spray boom system of a vehicle transporting a fluid reservoir, comprising:
removably attaching at least one cap of a quick attachment spray boom of the spray boom attachment system to a nozzle of the second spray boom system;
removably attaching a fluid supply hose to a hose adapter of the quick attachment spray boom, to provide fluid communication between the fluid reservoir and the quick attachment spray boom;
spraying fluid from the fluid reservoir from at least one nozzle body of the quick attachment spray boom.

14. The method according to claim 13, further comprising changing the nozzle spacing of the second spray boom system by removably attaching the quick attachment spray boom to the second spray boom system.

15. The method according to claim 13, further comprising changing the effective height for spraying by removably attaching the quick attachment spray boom to the second spray boom system.

16. The method according to claim 13, further comprising removably attaching a plurality of quick attachment spray booms to the second spray boom system.

17. The method according to claim 16, wherein the spraying fluid comprises using the plurality of quick attachment spray booms.

18. The method according to claim 13, further comprising removably attaching a plurality caps of the quick attachment spray boom to the second spray boom system.

19. The method according to claim 13, further comprising reversing the removably attaching the fluid supply hose and reversing the removably attaching the at least one cap to remove the quick attachment spray boom from the second spray boom system.

20. The method according to claim 14, wherein changing the nozzle spacing of the second spray boom system changes the nozzle spacing to less than or more than 20 inches.
